(19) United States
(12) Patent Application Publication
(10) Pub. No.: US 2021/0297278 A1
(43) Pub. Date: Sep. 23, 2021

(54) METHOD FOR CONTROLLING INTERNET HOME APPLIANCE SYSTEM

(71) Applicant: LG ELECTRONICS INC., Seoul (KR)

(72) Inventors: Yongha LEE, Seoul (KR); Manjae LEE, Seoul (KR); Junebern YI, Seoul (KR)

(73) Assignee: LG Electronics Inc., Seoul (KR)

(21) Appl. No.: 16/489,689

(22) PCT Filed: Sep. 28, 2018
(86) PCT No.: PCT/KR2018/011543

§ 371 Date: Aug. 28, 2019

Related U.S. Application Data
(60) Provisional application No. 62/564,593, filed on Sep. 28, 2017.

(51) Int. Cl. H04L 12/28; G06F 3/0484; G06F 3/0482; G06K 7/14; G06K 7/10; D06F 34/05

(52) U.S. Cl. CPC H04L 12/2807; G06F 3/04847; G06F 3/0482; D06F 34/05; G06K 7/1417; G06K 7/10366; G06K 7/1413

(57) ABSTRACT

The present invention relates to an internet home appliance and a method for controlling the same, or an internet home appliance system and a method for controlling the same. According to an embodiment of the present invention, there may be provided a method for controlling an internet home appliance system, the method comprising the steps of: recognizing first information by an external terminal through an information tag provided on a product to be treated: transmitting second information to a server by the external terminal by using an application that interworks with a home appliance which is registered on the server on the basis of user information and appliance information, and which is communication-connected there to: receiving third information from the server by the home appliance and setting information (product treatment information) for treating the product: and treating the product by the home appliance on the basis of the product treatment information that has been set.

### FIELD

Embodiments of the present disclosure relate to an internet home appliance and a control method of the same or an internet home appliance system and a control method of the same.

### BACKGROUND

A home appliance means an electric appliance that is configured to perform a specific function by means of an electric or thermal energy, instead of a user.

Especially, there is one that is configured to process an object among the home appliances and diverse types of home appliances can be provided according to types of objects.

A laundry treating apparatus configured to treat clothes, as one example of the home appliances, includes a washing machine for washing clothes, a dryer for drying clothes and a clothes-management apparatus for refreshing clothes. The clothes-managing apparatus is adapted to refresh the clothes hung therein through dust and bad smell removing or drying and it is getting popular. Such the clothes-managing apparatus is called as a clothes-cleaner, refresher, styler or the like.

A refrigerator, a freezer or a wine cellar means a home appliance adopted to keep food or wine at proper temperatures.

An air conditioner or an air cleaner means a home appliance actuated to clean air or dust in a surrounding environment and keep a proper temperature, humidity and dust concentration value.

A vacuum cleaner means a home appliance that is actuated to vacuum and eliminate dust from a cleaning object (e.g., a floor, a carpet, bedding or a wall).

A water purifier or a water supplier means a home appliance actuated to supply purified water or drinking water. The water purifier or supplier may set the temperature of the purified water and kinds of driving water and then supply the purified water at the preset temperature or preset coffee. In this instance, a processing object may be milk powder, tea, coffee and other diverse types. As one example, the water purifier may be set to supply purified water at a specific temperature as by a specific amount.

Such home appliances have diverse modes, courses or cycles to as to optimally and effectively treat the objects. Of course, terminology may be variable according to the types of the home appliances. An option implemented to change control elements configured to vary such modes or cycles may be provided.

As one example, the washing machine provides a plurality of cycles or courses based on types of laundry fabric or contamination levels and a user is able to select a specific cycle or course according to the fabric type or condition wishes to wash. In addition, the washing machine may include options configured to vary control elements for controlling the temperature of wash water, the dry-spinning RPM, the amount of the wash water.

Product processing information may include high rank control information (e.g., a course, mode or cycle) and low rank control information.

Accordingly, the user has to take the trouble of selecting the optimal processing information based on the object that wishes to process among plural pieces of object processing information. There is little inconvenience for some users who are used to such the trouble or able to perform the optimal selection. However, in case plural pieces of high rank control information are provided and consequent plural pieces of low rank control information are provided, it is not easy to select or set proper control information and some users frequently use only basic control information.

When the processing objects are high price clothes, it is not easy to make optimal selection among the plural object processing information pieces. In other words, wrong choice is likely to result in damage to clothes and then deterioration of home appliance reliability.

For instance, if the user selects a piece of processing information configured to expose the laundry that is sensitive to temperatures to a high-temperature heat or steam of high-temperature wash water, the sensitive fabric laundry is more likely to damage. Also, if refreshing clothes like a padded jacket, sufficient refreshing might not be performed only by air spraying.

Accordingly, it is needed to guide the user to make an optimal selection among plural pieces of object processing information.

Recently, it is commercialized to guide the optimal object processing information when the user inputs information on a processing object by means of an application of an external terminal (e.g., a smart phone).

In addition, it is also commercialized to allow the user to download customized processing information or new processing information from the home appliance, not the processing object information provided via the home appliance by default.

As one example, the user is able to execute an application of a smart phone, in connection with the corresponding home appliance and then download processing information that is able to optimally a specific processing object. In other words, when the user contacts a server through the smart phone and selects download information, the server allows the selected information to be downloaded to the home appliance. The user may process a specific processing object through specific processing information of the downloaded information.

However, such a process is very complex and performed in multi steps disadvantageously. Hereinafter, a step of downloading product processing information (course information) of a clothes-managing apparatus as one example of the home appliance will be described.

When an integrated application connectable with plural types of home appliances and a home appliance application connectable with a specific type of a home appliance are required, a following process will be implemented.

First of all, the user may execute an integrated application (e.g., “Smart ThinQ”) through an external terminal and then select to execute an application for a home appliance wished to use (e.g., “Styler”). Once the user selects Styler, a current state image may be displayed on the external terminal. When the user selects an extension tab from the state image, a course tab image may be displayed on the external terminal. Hence, when the user selects a course tab, a course image may be displayed on the external terminal. When the user selects a download category from the course image, an image that shows downloadable courses may be displayed on the externa terminal. After that, the user may select a specific one from the downloadable courses of the download course image and determine a corresponding course download through the course tab image.

In other words, the user may select the download of the specific course through at least seven images on the external terminal. After that, the user may approach to the home appliance and select the downloaded course to push a start button.

Accordingly, together with the problem of the quite complex steps, there is another problem that it is not certain whether the downloaded specific course is an optimal one. That is because an error of the product information recognized by the user might lead the user to select a course, not the optimal course.

Accordingly, an invention is required that may minimize confusion in the user's selection of the processing information for processing the product and improve convenience of use, and also that may be easily useable by minimizing the steps or operations selected or recognized by the user.

### DETAILED DESCRIPTION OF THE INVENTION

### Technical Problem

To overcome the disadvantages, an object of the present invention is to address the above-noted and other problems.

Another object of the present invention is to provide a home appliance system that may prevent a possibility of a user's mal-recognition for information about a processing object and automatically set processing information based on accurate information about the processing object, and a control method of the same.

A further object of the present invention is to provide a terminal, a home appliance and a home appliance system that may be conveniently used by automatically executing an application that is connectable with the home appliance through an external terminal, and control methods of the same.

A still further object of the present invention is to provide a home appliance system that may minimize the operation manually performed by the user, when a user performs processing object through the home appliance, and a control method of the same.

A still further object of the present invention is to provide a home appliance system that may process a processing object only in a specific home appliance based on information about the processing object, and a control method of the same.

A still further object of the present invention is to provide a home appliance system of which an initial environment building is very easy by allowing the user to perform a process of installing an application in a terminal or registering a home appliance in a server to communicate through the terminal, and a control method of the same.

A still further object of the present invention is to provide a home appliance system that may create fusion and convergence synergy by enhancing consumer satisfaction for a home appliance configured to process a processing object, and a control method of the same. As one example, the consumer satisfaction for a specific clothing company, a manufacturer of an external terminal to which a specific OS is applied and a manufacturer of a specific home appliance is enhanced such that a synergy can be created in the related industries.

### Technical Solution

To achieve these objects and other advantages and in accordance with the purpose of the embodiments, as embodied and broadly described herein, a control method of an internet home appliance system comprises a step of recognizing first information from an information tag provided in a processing object product through an external terminal; a step of transmitting second information from the external terminal to a server by using an application registered in the server through user information and appliance information and communication-connectable with a home appliance; a step of transmitting third information to the server from the home appliance and setting information for processing the product (the product processing information) based on the transmitted information; and a step of processing the product based on the set product processing information in the home appliance.

The processing object produce may be a processing object. The processing object may be an object that is introduced into the home appliance and treated and that has information for performing a specific operation or function in the home appliance. Accordingly, the processing object may not mean only the object that has to be introduced into the home appliance necessarily. The processing of the produce in the home appliance may be expanded to the performing the specific operation or function in the home appliance based on information that is recognized from the processing object.

The information tag may include at least one of a bar code, a QR code and a wireless communication tag.

The external terminal may include a recognition module configured to recognize the information tag. The recognition module may include an infrared ray reader module, a camera module or a wireless communication module. The wireless communication module may include a RFID module or a NFC module. Only unidirectional recognition is required between the information tag and the wireless communication module and bidirectional communication may be excluded. Accordingly, the wireless communication tag may be the NFC tag and the wireless communication module may be the NFC module.

The control method of the internet home appliance system may further comprise a step of logging in the server through the external terminal by using the user information, while implementing the application. The server may match a specific home appliance based on the user information. In other words, the server may specify the corresponding home appliance.

The application may comprise an integrated application that is applicable to a plurality of different home appliances; and a home appliance application that is applicable to a specific home appliance after the integrated application is implemented. The home applications may be provided in the integrated application. Accordingly, one integrated application may be installed and the plurality of the home appliance applications may be then installed together.

The wireless communication tag may comprise NFC tag. Accordingly, the external terminal may implement the corresponding application.

Specifically, the external terminal may implement the specific application for the product processing, after recognizing the first information from the NFC tag and implementing the integrated application.

For that, the external terminal may be power-on before the tagging. OS of the external terminal may read the first information and implement the corresponding application.

The first information may comprise the product processing information or information configured to determine the product processing information.

The first information may be a specific course or include a specific course. The external terminal may determine a specific course based on the first information. Accordingly, the second information may be a specific course or include a specific course. Similarly, the external terminal may determine a specific course based on the second information. Accordingly, the third information may be a specific course or include a specific course.

The first information may comprise home appliance information configured to perform the product processing. Accordingly, a corresponding home appliance application may be implemented.

The first information may comprise information about an application implemented in the external terminal, information about a manufacturer or brand of the product and a type of the product. At least predetermined part of such the information may be displayed and the user may intuitionally figure out that the first information is recognized properly.

The second information may be equal to the first information or comprise at least predetermined part of the first information or the product processing information.

The third information may be equal to the second information or comprise at least predetermined part of the second information or the product processing information.

The second information may comprise product processing information that will be newly downloaded in the home appliance for the product processing.

An image may be displayed on the external terminal to allow the user to select the product processing information that will be newly downloaded.

The third information may comprise product processing information that is newly downloaded in the home appliance.

The newly downloaded product processing information may be set in the home appliance.

Accordingly, the product processing information provided by default may be automatically set and new produce processing information may be automatically set.

The application may comprise a home appliance application that is applicable to a specific home appliance. As one example, the home appliance application may be a styler application or a washing machine application. Such the home appliance application may be installed separately from the integrated application mentioned above.

The external terminal may recognize the first information from the NFC tag and implement a specific home appliance application for the product processing.

The corresponding application may be implemented after or before recognizing the first information. The implementation after the recognition may be performed automatically and the implementation before the recognition may be the implementation performed by the user's input.

The external terminal may recognize the first information and implement the application. In other words, the corresponding application may be automatically implemented.

The external terminal may implement the application and recognizes the first information. In other words, the corresponding application may be implemented by the user's selection and the first information may be recognized in the corresponding application. In this instance, an image for recognizing the first information may be displayed.

The home appliance may comprise an input unit configured to receive the user's input for setting the product processing information manually; a display unit configured to display the set product processing information; and a user interface unit configured to receive the user's input for starting the product processing based on the set product processing information.

According to this embodiment, the use of the input unit may be excluded. In other words, product processing information may be automatically set, without the input unit. Meanwhile. When the product processing information is automatically set, the input performed through the input unit may be excluded.

As one example, an alarm indicating that processing information is automatically set may be provided by the user interface unit. After that, in a state where such an alarm is effective, it is not recognized even when the user manipulates the input unit.

An image for installing the application may be displayed on the external terminal, unless the application is installed in the external terminal having recognized the first information. Accordingly, the application may be installed easily. In other words, it is very convenient to install the application at a proper point of time.

An image for registering the home appliance in the server may be displayed on the external terminal, unless a home appliance for the product processing is registered in the server in the external terminal having recognized the first information. In other words, the application may facilitate the easy registration of the home appliance at a proper time.

The home appliance may be registered in the server after the application is implemented such that it may not be needed to re-input user information. Especially, a home appliance without a key pad may be connected with the server by communication through the external terminal and registered in the server.

An image for allowing the user to select specific product processing information based on the first information may be displayed on the application implemented in the external terminal. As one example, specific course information may be displayed. The user is able to know the information automatically set and approve that.

The processing object product may comprise clothing, and the home appliance may comprise a washing machine, a dryer and a clothes management apparatus.

In another aspect, a control method of an internet home appliance system comprises a step of controlling a user to apply power through a power input unit manually selected by the user; a step of registering a home appliance in a server and connecting the home appliance with the server by communication; a step of receiving third information for product processing from the server and setting the product processing information; a step of receiving an input for starting the product processing through a start input unit selected by the user manually; and a step of processing the product based on the set product processing information, wherein the product processing information is set based on first information that is recognized from the product through an external terminal by the user, second information that is transmitted to the server from the external terminal, and third information that is transmitted to the home appliance from the server.

In other words, the user may not manually set product processing information but automatically set the product processing information.

In a further aspect, an internet home appliance system comprises a server, a home appliance connected with the server by communication and registered in the server, and an external terminal connected with the server by communication, wherein the home appliance comprises a user interface unit configured to set product processing information and a communication module configured to connect the home appliance with the server by communication, and the external terminal comprises a NFC module configured to recognize first information from a processing object product and a communication module mounted to transmit second information to the server, and an application implemented in connection with a home appliance communicable with the server is installed in the external terminal, and the server comprises a communication module configured to transmit third information to the home appliance to automatically set the product processing information in the home appliance.

In a further aspect, a control method of an internet home appliance system configured to support a home appliance to automatically set product processing information in the home appliance, the control method comprises a step of recognizing first information from an information tag provided in a processing object product through the external terminal; a step of recognizing the first information through the external terminal and implementing an application that is connectable with the home appliance registered in a server based on user information and appliance information by communication; and a step of implementing the application through the external terminal and transmitting second information to the server to automatically set the product processing information in the home appliance after the server transmits third information to the home appliance.

The control method of the internet home appliance may further comprise a step of displaying an image for installing the application, unless the connectable application is installed in the external terminal having recognized the first information.

The control method of the internet home appliance may further comprise a step of displaying an image for registering the home appliance in the server, unless the home appliance for the product processing is registered in the server after the external terminal recognizes the first information. The user may register the corresponding home appliance in the server easily by using the image.

The control method of the internet home appliance may further comprise a step of displaying an image for selecting specific product processing information based on the first information on the external terminal, while the application is implemented. The image may be an image for the external terminal to transmit information to the server. In other words, when the user identifies and approves specific information, the corresponding information may be transmitted to the server.

Accordingly, the user may perform only the tagging and approval through the external terminal. The external terminal may automatically perform a series of process such as implementation of the application, recognition and analysis of the first information and deriving of the optical information.

Thus, it is intended that the present disclosure covers the modifications and variations of this disclosure provided they come within the scope of the appended claims and their equivalents.

### Advantageous Effects

Accordingly, the embodiments have following advantageous effects. According to at least one embodiment of the present disclosure, the home appliance system may prevent a possibility of a user's mal-recognition for information about a processing object and automatically set processing information based on accurate information about the processing object.

Furthermore, the home appliance system may be conveniently used by automatically executing an application that is connectable with the home appliance through an external terminal.

Still further, the home appliance system may minimize the operation manually performed by the user, when a user performs processing object through the home appliance.

Still further, the home appliance system may process a processing object only in a specific home appliance based on information about the processing object.

Still further, the initial environment building the home appliance system may be very easy by allowing the user to perform a process of installing an application in a terminal or registering a home appliance in a server to communicate through the terminal.

Still further, the home appliance system may create fusion and convergence synergy by enhancing consumer satisfaction for a home appliance configured to process a processing object. As one example, the consumer satisfaction for a specific clothing company, a manufacturer of an external terminal to which a specific OS is applied and a manufacturer of a specific home appliance is enhanced such that a synergy can be created in the related industries.

### BRIEF DESCRIPTION OF THE DRAWINGS

FIG. 1 is a diagram illustrating a configuration of an internet home appliance system according to one embodiment of the present invention;

FIG. 2 is a diagram illustrating a first process provided in a control method of the internet home appliance system according to one embodiment;

FIG. 3 is a diagram illustrating a second process provided in a control method of the internet home appliance system according to one embodiment;

FIG. 4 is a diagram illustrating a third process provided in a control method of the internet home appliance system according to one embodiment;

FIG. 5 is a diagram illustrating one example of an image that is displayed on an external terminal and showing a user's tagging of an external terminal to a processing object product and an application executed on the external terminal after the tagging;

FIG. 6 is a diagram illustrating on example of an image displayed on the external terminal that is recognized and checked by the user to transmit processing information to a server from the external terminal; and

FIG. 7 is a diagram illustrating one example that the user introduces the processing object product to the home appliance and inputs a signal for actuating the home appliance.

### DESCRIPTION OF SPECIFIC EMBODIMENTS

Referring to the accompanying drawings, an internal home appliance system and a control method of the same according to exemplary embodiments of the present disclosure will be described in detail.

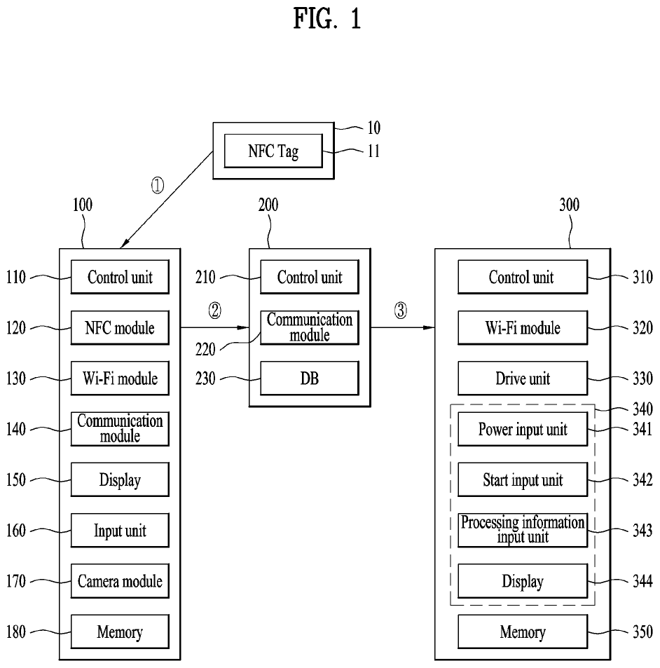

Referring to FIG. 1, elements of the internet home appliance system will be described in detail. While describing the elements, the control method of the internet home appliance is described in brief. For easy description sake, a styler that is a clothes-managing apparatus is adopted as one example of the home appliance.

As shown in FIG. 1, the internet home appliance system includes a terminal 100, a server 200, and a home appliance 300. Also, FIG. 1 shows an object 10 having a processing object product or processing information and an order of information transmission.

The processing object product 10 may include an information tag 11. Product processing information for the home appliance 300 may be set based on the information stored in the information tag 11 and transmitted to the external device 100.

The product processing information may include logic for actuating the home appliance 300 or control elements configured to perform the logic. Accordingly, once the product processing information is set, the home appliance may be actuated according to the set product processing information.

When the home appliance 300 is the styler and the processing object product 10 is clothing, an optimal course or cycle is set in the clothing and the styler may actuate according to the optimal course or cycle. In other words, the clothes loaded in the styler have an information tag 11 and the external terminal 100 receives the first information stored in the information tag 11 to set the product processing information in the home appliance 300. Once setting the product processing information, a user may introduce the clothes into the styler and the styler may actuate according to the set product processing information to treat the clothes.

The processing object product 10 may not necessarily mean the product introduced into the home appliance 300. In other words, the processing object product 10 may be an object having information for setting the processing information of the home appliance. Also, the processing object product 10 has to be independently provided from the external terminal 100, the server 200 and the home appliance 300.

As one example, when the home appliance 300 is a water purifier, the processing object product 10 may be milk powder. An information tag 11 may be provided on a milk powder case and the information tag 11 may have information for setting the temperature and amount of the hot water supplied by the water purifier. In a large sense, it can be said that the milk power is the processing object product having the processing information of the water purifier, even unless the milk powder itself is introduced into the water purifier.

The information tag 11 may be provided in diverse types. Examples of the information tag 11 include a bar code, a QR code and a wireless communication tag. Such the information tag 11 may be attached to insides or outsides of the clothes or it may be provided in a wappen attached to the clothes.

When the information tag 11 is a bar code or QR code, the external terminal 100 has to include a module implemented to recognize or read the information tag 11. The external terminal may include a code reader or camera module 180. Accordingly, the external terminal may recognize or receive first information from the processing object product 10 through the recognition module.

The external terminal 100 may be a smart phone and include diverse applications. An application may be installed in the external terminal to use the recognition module such as a code reader or a camera module. Accordingly, when using the code reader or the camera module, the user has to implement a specific application.

When the recognition module recognizes the first information, OS may implement an application for a connectable home appliance in the external terminal. The implementation of the application may be automatically performed.

In case the information tag 11 is the wireless communication tag, it is not necessary to precede the implementation of the recognition module application. In case the wireless communication tag is an NFC tag, the user is able to tag the external terminal on the information tag 11 in a switch on state. At this time, NFC module has to activate in an external terminal control setting in advance.

Accordingly, when the information tag 11 is the NFC tag as one example of the wireless communication tag, it is not necessary to precede implementation of a specific application to read or recognize the first information from the information tag 11. In other words, when recognizing the first information in a standby state or locked state, OS may implement an application of a connectable home appliance in the external terminal so as to make use quite convenient.

The external terminal 100 may include a Wi-Fi module 130. The Wi-Fi module 130 may be configured to register the home appliance 300 in the server 200 and communicate with the server 200, instead of the home appliance 300.

The external terminal 100 may also include a communication module 140 for communication such that the user can make a voice or video call. 5G The communication module has reached commercialization as the communication module.

The Wi-Fi module 130 may be configured to facilitate internet use, instead of the communication module 140. In the control setting of the external terminal, the user is able to set the activation of the communication module 140 or the Wi-Fi module 130.

In addition, the external terminal 100 may include a display unit 150 and an input unit 160. The display unit 150 may be a touch display and the user's selection or input may be facilitated by touch, with a display function. The input unit 160 may be a power button or volume button.

The external terminal 100 may include a memory 180 and user information for log in the server 200 may be stored in the memory 180.

Also, the external terminal 100 may further include a control unit or main processor. The OS installed in the control unit 110 may control the drive of the external terminal.

A control method of the internet home appliance system according to one embodiment may start with a step of recognizing or receiving the first information from the external terminal 100 through the information tag 11 provided in the processing object product 10.

An integrated application may be installed in the external terminal 100 to control or monitor diverse types of home appliances by remote control. A home appliance application configured to control or monitor a specific home appliance by remote control may be installed in the external terminal 100.

First of all, the integrated application is executed and a home appliance the user wishes to control is selected. Then, a specific home appliance application may be executed in the terminal. Of course, only a specific home appliance application may be installed, without the integrated application.

As examples of the integrated application include “Smart ThinQ” of LG Electronics. Such ‘Smart ThinQ” may facilitate the implementation of diverse home appliance applications for specific home appliances including a refrigerator, a washing machine, dryer, a styler and the like.

Unless the integrated application (e.g., “Smart ThinQ”) is installed, only respective applications for controlling the respective refrigerator, washing machine, dryer, styler and other home appliances may be installed.

Such the application may provide user with information and gain the user's approval.

The external terminal may log in the server 200 through the integrated application or home appliance application. In other words, the external terminal has to log in the sever 200 through user information. Upon initial logging in, the user information has to be input. Upon logging in after that, the external terminal may automatically log in the server through the user information stored in the memory 180.

The reason why the external terminal has to log in through such the application is that the server 200 has to specify one of the plural home appliances connected with the server 200 by communication. In other words, the server 200 has to set processing information about a specific home appliance that will be used by a specific user, not the other home appliances.

Once the external terminal 100 recognizes the first information, second information is transmitted to the server 200 and the server 200 receives the second information from the external terminal 100. At this time, the external terminal 100 logs in the server 200 through an application and transmits the second information to the server 200. Accordingly, the server 200 may receive not only the second information but also the user information. Also, it may receive information about the home appliance.

Meanwhile, the integrated application or home appliance application may not be installed in the external terminal 100. In this instance, it is meaningless that the external terminal 100 transmits the second information to the server 200, because the server 200 cannot specify one user and one home appliance.

Accordingly, it is necessary to guide the user to install the application easily. For that, the first information may include application information, which will be described in detail later.

The home appliance is registered in the server through the same user information and connected with the server by communication. In this instance, the server 200 is able to specify one home appliance. In other words, the user may automatically specify the home appliance of which processing information is wished to set through the external terminal.

Meanwhile, even when the integrated application or the home appliance application is installed in the external terminal 100, the home appliance 200 may not be registered in the server 200. The application may not be installed and the home appliance 200 may not be registered. In this instance, it is meaningless that the external terminal 100 transmits the second information to the server 200. That is because the server 200 is not able to specify one user and one home appliance. However, even when specifying the user, the server is not able to specify the home appliance.

Accordingly, it may be necessary to guide the user to register the home appliance in the server. For that, unless the home appliance is registered in the server, the integrated application or the home appliance application may guide a process of registration or register the home appliance in the server, which will be described in detail later.

The server 200 may function to intermediate between the external terminal 100 and the home appliance 300. This function may not mean simple intermediation but data processing and determination. For that, the server 200 may include a control unit 210 and a data base 230. Also, it may include a communication module 220 configured to facilitate communication between the external terminal 100 and the home appliance 300.

The server 200 is able to keep a communication state with the home appliance, while it has the home appliance 300 registered therein in a state of being switched on. Also, an input unit or input means for selecting activation of communication connecting may be provided in the user interface 340 of the home appliance 300.

Once the server 200 receives the second information from the external terminal 100, the server 200 may transmit third information to the home appliance that is registered in the server and communicably connected there with. The home appliance may receive the third information from the server.

Information for processing the product, in other words, product processing information may be set in the home appliance 300 based on the transmitted third information.

Accordingly, the user may only perform the recognition of the first information through the external terminal but not set the product processing information in the external terminal 100 manually.

The home appliance 300 may process the product based on the set processing information.

The home appliance 300 may be fixedly installed or movable only in a predetermined space in a room. Accordingly, such the communication module like the communication module 140 of the external terminal 100 may not be provided. In other words, it is possible for the home appliance to communicate with the server 200 through the Wi-Fi module 320.

Basically, the home appliance 300 may include a user interface 340 configured to facilitate the user's manual setting of the processing information or inform the user of the processing information. The user interface unit 340 may be provided in a front or top surface of the home appliance 300. Especially, the user interface unit 340 may be integrally formed with a front surface of the door as one body.

The user interface unit 340 may include a power input unit 341 configured to receive the user's input for applying power to the home appliance. The power input unit may be omitted in the home appliance to which the power is always applied like the refrigerator. The power input unit has to be provided in the home appliance that is driven only when necessary like the washing machine, styler or the air cleaner. The power input unit may be a switch, a button, a touch panel or the like.

The user interface unit 340 may include an input unit or a processing information input unit 343. The processing information input unit 343 may be configured to facilitate the user's manual setting of diverse processing information including selection of a course or cycle and selection of an option. Accordingly, a plurality of input units or a touch display may be provided as the processing information input unit 343.

The user interface unit 340 may include an implementation input unit or a start input unit 342. The start input unit 343 may be configured to allow the user to select the start input unit 343 to start the actuation of the home appliance according to the set processing information. In this instance, a control unit 310 configured to control the operation of the home appliance may be provided.

The home appliance 300 may include a plurality of drive unit 330 and the drive units may be realized in diverse types according to the type of the home appliance.

The styler may include a drive unit configured of diverse elements including a fan configured to supply or circulate air; heating means (e.g., a heater or a heat pump) configured to generate hot air; a steam generator; an actuator configured to shake a hanger; and various sensors.

The washing machine may include a drive unit configured of diverse elements including a water discharge pump, a water supply valve, a drum drive motor, a heater and various sensors.

The refrigerator may include a drive unit configured of diverse elements including a compressor, an expansion valve, a cold air circulating fan and various sensors.

The user interface 340 of the home appliance may include a display unit or display 344. The display may be configured to display status information or processing information of the home appliance. Also, in case the user interface is a touch display, the display may serve as the user input function.

As mentioned above, the home appliance 300 may communicate with the server through the Wi-Fi module 320. For that, the home appliance 300 has to be registered in the server.

To facilitate the communication of the home appliance 300 with the server through the Wi-Fi module 320, AP (Access Point) is necessarily provided in a building. Accordingly, the home appliance 300 may recognize information for AP and provide needed information to AP.

If the display 344 is a touch display, AP information may be displayed on the display 344 and the user may select the AP displayed on the display 344 so as to input a code of the selected AP.

The home appliance 300 may have unique appliance identify (ID). The appliance ID may have appliance information. Such the appliance ID may be automatically transmitted to the server when the home appliance is connected with the server by communication. The appliance ID may be embedded in the home appliance and automatically transmitted to the server or the user may input the appliance ID to the home appliance.

Meanwhile, the home appliance 300 may be registered in the server, together with the user information. When the user remotely controls or monitors the home appliance in the external terminal via the server, the server has to specify one home appliance as the object. Accordingly, when the home appliance 300 is connected with the server to communicate, the user information may be transmitted to the server from the home appliance.

If the display 344 is a touch display, the user may input user information on the display 344.

However, in case of a home appliance without a touch display or auxiliary key pad, it is not easy to connect the home appliance with the server by communication and register the home appliance in the server.

For that, the Wi-Fi module 320 may provide an access domain. The Wi-Fi module 320 may access to the home appliance via the access domain and provide information about the registration and communication connection of the home appliance to the home appliance.

Such information may include user information, AP information and a code or password of a specific AP. The information may include the appliance ID. The detailed description about the registration of the home appliance in the server through the external terminal and the communication connection between them will be provided later.

Hereby, the internet home appliance system according to one embodiment and the control method of the same are described in brief. Hereinafter, the diverse information described in the above-noted embodiment will be described in detail.

The first information stored in the information tag 11 of the processing object product 10 and recognized in the external terminal 100 may ultimately mean the information that is necessary to set the processing information in the home appliance.

The first information has to have the restricted amount of information, due to the restricted information recognition means and the restricted recognition time. Accordingly, the first information may include product processing information or information for determining the product processing information. The styler may include a specific course name and clothing information for specifying one course.

The first information may include home appliance information configured to processing the product. Especially, the first information may include home appliance information that has to be used to process the product. When the processing object product is a piece of clothing, a home appliance (e.g., a washing machine, a dryer or a styler) for treating the clothing maybe used. As one example, when the corresponding clothing is one piece that has to be excluded from water-washing or wrinkling introduction, the first information may include styler information as the home appliance information.

The first information may include a manufacturer of the processing object product, a brand and type of the product.

The first information may also include application information. The above-noted integrated application or specific home appliance application.

The first information may have several data that may be separated from each other by a separator and provided as follows:

Example of the first information: “com.lgeha.nuts,203,1,1,11,216”

Sequentially, “com.lgeha.nuts” means the name of Smart ThinQ application that is registered in Android OS and “203” means the styler as the home appliance information. “1” means “reserve” for later expansion and “1” means Black Yak that is the name of the collaborated company. “11” means a padded jacket as the collaborated company product information and CRC means the added value of the above information values to detect an error of the received data.

Such the first information may be modified into other various examples, except the above-noted example.

Once the external terminal 200 recognizes the first information, OS of the external terminal 200 may implement a corresponding application to the application information. Upon implementing the integrated application, the styler application may be implemented according to the home appliance information or the corresponding home appliance application may be implemented without the integrated application.

Upon the implementation of the application, the external terminal automatically logs in the server and the information data recognized based on the first information may be displayed on the image of the application.

The user may allow the second information to be transmitted to the server from the external terminal by approval, selection or input on the image of the application.

The second information may be the first information as it is or include some data of the first information. The second information may be the information data processed, modified or derived from the first information.

When the first information includes specific course information (e.g., “Black Yak padded jacket management course”), the user may identify the information on the external terminal and select to transmit the second information to the server. At this time, the second information may be “Black Yak padded jacket management course”. In this instance. The first information may be equal to the second information and the external terminal may perform only the tossing of the information to the server as it is.

When the first information includes specific clothing information (e.g., “Padded jacket”), the external terminal may analyze the first information and propose “a padded jacket course” as the optimal course. Accordingly, the second information may include at least some data of the first information or information that is processed or derived from the first information.

When the first information incudes specific clothing information having a brand name or clothing company data (e.g., “Black Yak padded jacket”), the external terminal may analyze the first information and propose “Black Yak padded jacket management course” as the optimal course. Accordingly, the second information may include at least some data of the first information or information that is processed or derived from the first information.

Once it receives the second information from the external terminal, the server may transmit the third information to the home appliance.

The third information may be equal or similar to the first information and the second information. As one example, when “Padded jacket management course” is provided in the home appliance by default, the third information may include only the simple information of “Padded jacket management course”.

As it is a general-purpose device, the home appliance may be provided only to treat the clothing manufactured by a specific clothing company. Accordingly, the home appliance may not include “Black Yak padded jacket management course” by default, for example, and the server uploads a new type of processing data to the home appliance. In other words, the home appliance downloads a new type of processing data from the server. In this instance, the third information may include not only the name of “Black Yak padded jacket management course” but also information about specific diverse control elements.

Accordingly, the user is able to clearly recognize the treating process of the product performed in the home appliance based on optimal processing data, fitted processing data or my processing data provided in the “Black Yak padded jacket management course” displayed on the external terminal.

Specifically, the product processing information that has to be downloaded newly may be displayed on the external terminal and the user may select it on the external terminal such that he or she can intuitionally recognize such utility. Here, the second information may include the product processing information that has to be downloaded newly.

Therefore, the user will feel satisfied with not only the processing object product itself but also the home appliance. Also, the user will feel satisfied with the external terminal that is capable of facilitating such the application.

Accordingly, synergy may occur in the related industries as well as the specific industry. That is because the user will purchase corresponding products and corresponding home appliances and corresponding external terminals consistently after such experience.

It may be excluded that the user recognizes the product information and select the processing information based on the recognized product information. Then, it may be prevented in advance that the user misrecognizes the product information or select work processing information. The user may perform only simple action like the recognition of the first information through the external terminal, the identifying of the product processing information, the introduction of the product into the home appliance and the selection of the start input unit.

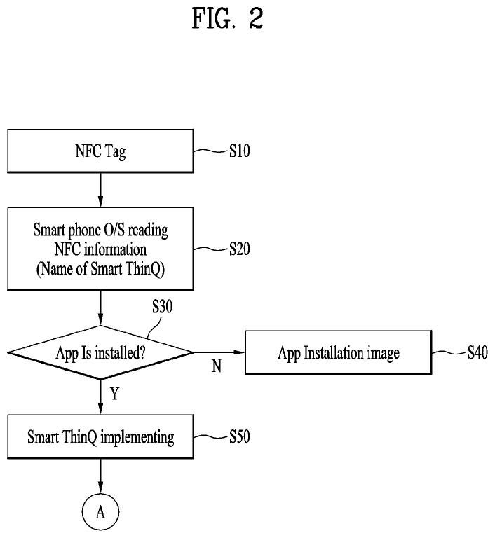

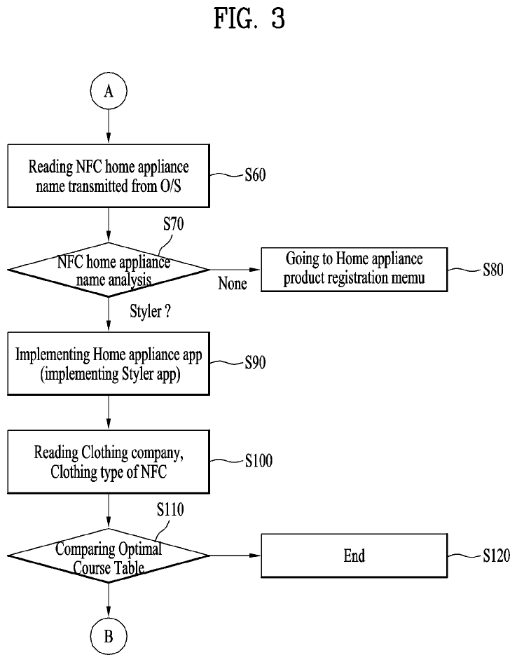

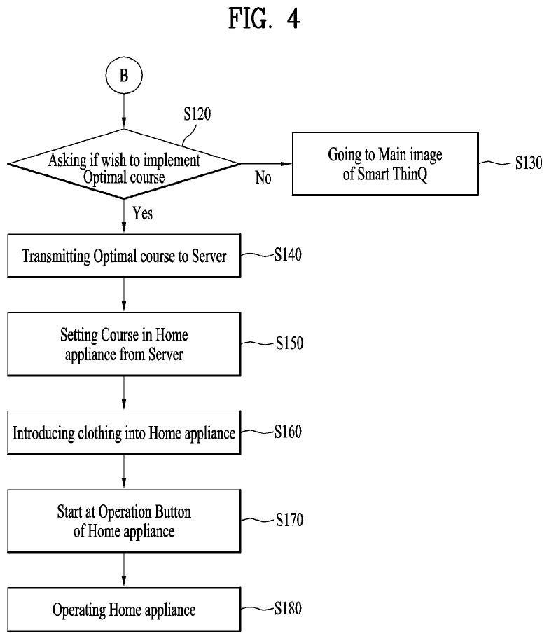

Hereinafter, referring to FIGS. 2 through 4, the control method of the internet home appliance system according to one embodiment will be described in detail. FIG. 2 illustrates control flow of a first process and FIG. 3 illustrates control flow of a second process. FIG. 4 illustrates a control flow of a third process. It may be sure that the control method is very intuitionally and simply realized through the three processes.

The first process may mean a process configured to implement “Smart ThinQ” provided as the integrated application based on the information read from NFC tag by OS of the external terminal.

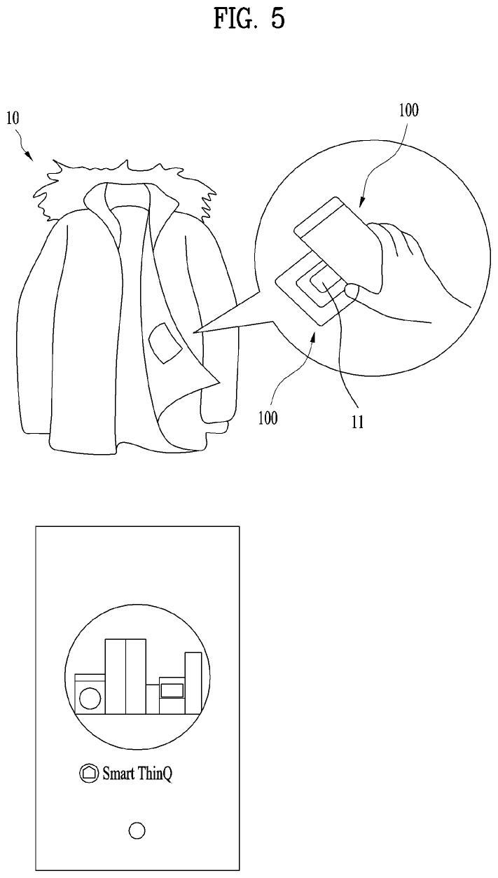

First of all, the user may tag the external terminal on NFC tag that is attached to a piece of clothing, while the external terminal is powered on S10. It is shown in FIG. 5 that the user is tagging the external terminal on NFC tag of the clothing.

Once tagging the external terminal on NFC tag attached to the clothing, OS of the external terminal may read or recognize FNC information S20.

NFC information may include information about a corresponding application and OS of the external terminal may read the NFC information and determine whether to install the corresponding application S30. After that, OS may implement the corresponding application S50. FIG. 5 illustrates an image that shows the integrated application implemented after the tagging of the external terminal.

Unless the corresponding application is installed, an image may be displayed on the external terminal to install the corresponding application S40. As one example, an image indicating to download the corresponding application from Play store of Google may be displayed on the external terminal.

The user may download and implement the corresponding application and input user information such that he or she can log in the server through the corresponding application. At this time, the user information may be the data for subscribing to the server or use the user information used in subscribing to the portal sites like Google, Facebook, Naver or Daum.

Accordingly, the server is informed that a specific user contacts the server through the external terminal based on the log-in user information.

When the corresponding application is preinstalled in the first process, the user may perform only the tagging of the external terminal on NFC tag of the clothing in the first process.

In this embodiment, even unless the integrated application is preinstalled, the integrated application may be simply and smoothly installed at a proper point of time.

The second process may mean a process configured to analyze optimal product processing information in the integrated application.

The integrated application may read the NFC home appliance information transmitted from OS of the external terminal S60. In other words, the integrated application for several home appliances may analyze home appliance information that is connectable with NFC information and implement a corresponding home appliance application based on the analyzed information.

For that, the integrated application may analyze the name of the NFC home appliance S70 and implement a corresponding home appliance application (e.g., a styler application) S90. Here, the styler application may be some part of the integrated application. In other words, the integrated application is installed together with respective home appliance applications.

When the styler has to be used according to NFC information, the styler has to be registered in the server. The server has to provide a specific styler with information for setting product processing information.

Unless the styler as one example of the corresponding home appliance analyzed in the NFC home appliance name analyzing step S70 is registered in the server, the external terminal may display an image or menu for registering the home appliance S80.

The registration image may be displayed on the integrated application. In other words, it may be an image displayed after the user logs in. accordingly; additional user information input may not be needed for the home appliance registration.

An access domain address of the home appliance may be input or an access domain address of the home appliance may be read via the registration image. In this instance, the power of the home appliance has to be applied. When the home appliance is accessed via the registration image, the Wi-Fi module of the home appliance is communicably connected with the server via AP and information may be input from the external terminal to register the home appliance in the server.

AP data or AP password may be input to the image of the external terminal. The user may select AP that is useable in a building and input a password of corresponding AP to the external terminal. Such data may be transmitted to the home appliance and connect the home appliance with the server via AP. Of course, the home appliance may be registered in the server, together with the user information transmitted through the external terminal. An appliance ID of the home appliance may be registered in the server together with the user information.

Based on the server registration and communication connection of the home appliance, the server may figure out which product is connected thereto via which AP.

Accordingly, even when the home appliance is not registered in the server, it is possible according to the embodiment to register the home appliance in the server at a proper point of time.

When the corresponding application is implemented S90, the corresponding application may read the name of the clothing company and the type of the clothing from NFC information S100. In other words, the implemented home appliance application may read the clothing company name and the clothing type and propose a course optimized for the corresponding clothing to allow the user to select the optimized course in the corresponding home appliance.

In case a plurality of optimal courses is provided, a step of comparing the optima courses with each other S110 may be performed. At this time, the user is allowed to select one of the optimal courses. One optimal course may be provided or course information of one optimal course may be included in NFC information. When no optimal course is provided, the application may end 120.

Upon the application of the externa terminal implementing the second process configured to analyze the optimal processing information, the third process configured to transmit optimal processing information to the home appliance may be performed.

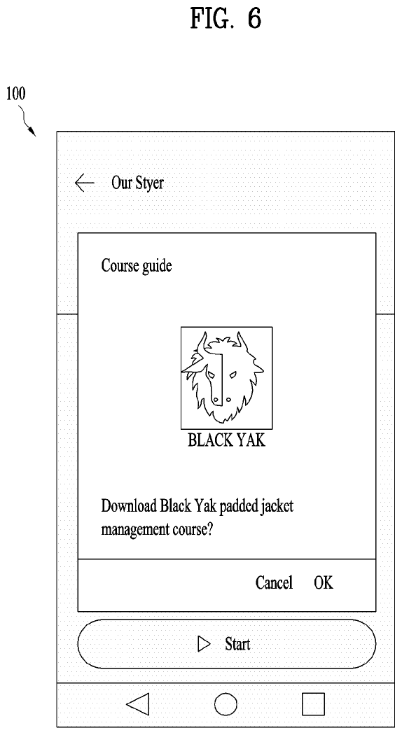

The external terminal may display the optimal processing information and a question for asking the user for approval may be displayed S120. One example of such question image is shown in FIG. 6. when “Black Yak padded jacket management course” is stored in the home appliance by default or preset in the home appliance, a question of “set Black Yak padded jacket management course?” may be displayed on an image shown in FIG. 6. Unless “Black Yak padded management course” is defaulted or preset, such the course has to be downloaded in the home appliance. In this instance, a question shown in FIG. 6 may be displayed. When the user selects “OK” on the image shown in FIG. 6, the external terminal may transmit optimal processing information to the server 5140 and the server may transmit the information to the home appliance to set the optimal processing information in the home appliance S150.

Accordingly, the third process may mean the process configured to transmit the information from the external terminal to the server and then the home appliance.

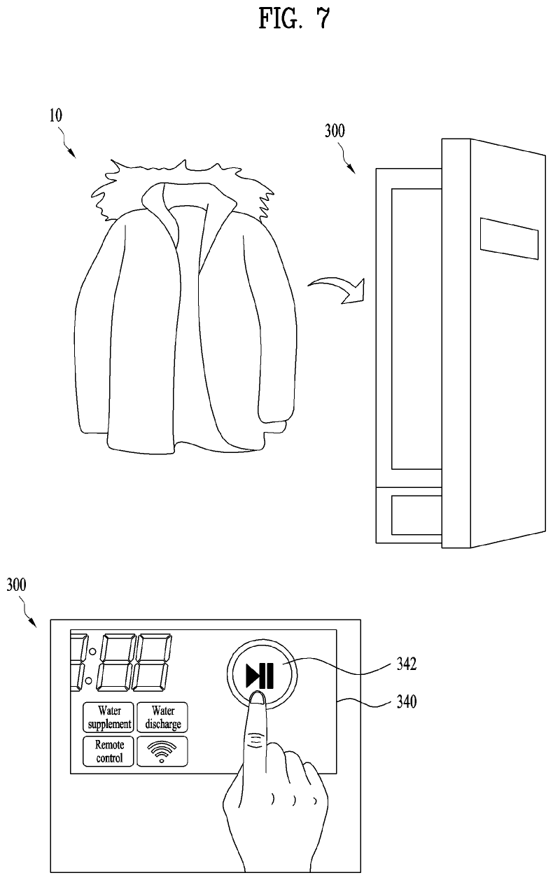

The user may introduce the corresponding clothing in the home appliance in which the optimal processing information is preset S160 and select the start input unit of the home appliance 5170. After that, the home appliance may actuate and treat the object based on the optimal processing information. FIG. 7 illustrates that the user is introducing the clothing into the styler and selecting the start input unit.

It can be said that the third process requires only simple performance of identifying and approving the processing information set through the external terminal after introducing the processing product into the home appliance and selecting the start input unit. In other words, the consideration about how to set the processing information and the setting of the processing information may be excluded. Accordingly, it may be prevented in advance that the user sets the processing information inappropriately.

Also, the conventional process mentioned above, in other words, the course setting or downloading through the external terminal may have at least seven steps that have to be performed by the user through the external terminal inconveniently. The user has to implement the integrated application, select the corresponding application and the expansion tap, the course tap and the download category, search and select a course to be downloaded and determine a course that will be downloaded.

However, in the embodiment, the user performs only two steps through the external terminal to set and download the course through the external terminal. A first step of the two steps shown in FIG. 5 may tag the external terminal on the processing object product and then the second step shown in FIG. 6 may allow the user to identify and select the optimal processing information. Accordingly, use convenience may be enhanced.

Meanwhile, the first process and the second process described above may be simplified more, because they can be used only in a specific home appliance application, not the integrated application.

As one example, NFC information may include specific home appliance application information, in other words, styler application information. in this instance, clothing may be processed only in the styler.

The name of the styler application may be read in the step S20 and it is determined whether the corresponding application is installed S30. An installation image for the corresponding application may be displayed S40 and the corresponding application may be implemented S50.

The step S60 may be omitted and S90 may be integrated with S50. After the corresponding application is implemented. S70 may be a step of determining whether the styler is registered. When the styler is registered, S100 may be performed. Alternatively, unless the styler is registered, S80 may be performed.

Hence, the other steps may be performed equally or similarly. In S130, a current image may be changed into a main image of the styler application, not a main image of the integrated application.

Meanwhile, the external terminal may read or recognize the processing object product before implementing the corresponding application according to the above-noted embodiment.

However, the external terminal may read or recognize the processing object product after implementing the corresponding application.

As one example, a menu or image may be displayed to read information about the processing object product after implementing the styler application. At this time, the user may tag the external terminal on NFC tag. Alternatively, the user may photograph a bar code or QR code provided on the processing object product by using the camera module. In other words, the user may locate the bar code or the QR code at a specific position on the image of the external terminal and the camera module may photograph the bar or QR code such that the external terminal may read the information of the processing object product.

The following steps may be equal to the steps of the above embodiment. In this instance, the corresponding application has to be installed from the start necessarily and it may be difficult for the user to use the application.

As a result, the processing object product information may include corresponding application information.

When the user manually sets the product processing information in the home appliance, a plurality of selections may be needed. The user frequently and properly one specific one of the plural courses and specific options. In addition, when downloading specific processing information, the user frequently has to have access to several downloadable data and select the optical download data in a complex process.

However, according to the above-noted embodiment, the user is able to automatically set the optical processing information easily and conveniently through the simple tagging process. If necessary (e.g., in the first use), the installation of the application or the registration of the home appliance may be performed through the external terminal easily.

In addition, according to the embodiment, the internet home appliance system and the control method of the same may integrally use or easily set one to several different internet home appliances.

“Smart ThinQ” and “Styer” that are mentioned above may be the names of the brands.

### INDUSTRIAL APPLICABILITIES

Industrial applicability of the present invention is included in the description of the specific embodiments.

1. A control method of an internet home appliance system comprising:
a step of recognizing first information from an information tag provided in a processing object product through an external terminal;
a step of transmitting second information from the external terminal to a server by using an application registered in the server through user information and appliance information and communication-connectable with a home appliance;
a step of transmitting third information to the server from the home appliance and setting information for processing the product (the product processing information) based on the transmitted information; and
a step of processing the product based on the set product processing information in the home appliance.

2. The control method of the internet home appliance system according to claim 1, wherein the information tag comprises at least one of a bar code, a QR code and a wireless communication tag, and
the external terminal comprises a recognition module configured to recognize the information tag.

3. The control method of the internet home appliance system according to claim 1, further comprising:
a step of logging in the server through the external terminal by using the user information, while implementing the application.

4. The control method of the internet home appliance system according to claim 3, wherein the application comprises,
an integrated application that is applicable to a plurality of different home appliances; and
a home appliance application that is applicable to a specific home appliance after the integrated application is implemented.

5. The control method of the internet home appliance system according to claim 4, wherein the wireless communication tag comprises NFC tag, and
the external terminal implements the specific application for the product processing, after recognizing the first information from the NFC tag and implementing the integrated application.

6. The control method of the internet home appliance system according to claim 1, wherein the first information comprises the product processing information or information configured to determine the product processing information.

7. The control method of the internet home appliance system according to claim 6, wherein the first information comprises home appliance information configured to perform the product processing.

8. The control method of the internet home appliance system according to claim 6, wherein the first information comprises information about an application implemented in the external terminal, information about a manufacturer or brand of the product and a type of the product.

9. The control method of the internet home appliance system according to claim 1, wherein the second information is equal to the first information or comprises at least predetermined part of the first information or the product processing information.

10. The control method of the internet home appliance system according to claim 9, wherein the third information is equal to the second information or comprises at least predetermined part of the second information or the product processing information.

11. The control method of the internet home appliance system according to claim 9, wherein the second information comprises product processing information that will be newly downloaded in the home appliance for the product processing, and
an image is displayed on the external terminal to allow the user to select the product processing information that will be newly downloaded.

12. The control method of the internet home appliance system according to claim 9, wherein the third information comprises product processing information that is newly downloaded in the home appliance, and
The newly downloaded product processing information is set in the home appliance.

13. The control method of the internet home appliance system according to claim 3, wherein the application comprises a home appliance application that is applicable to a specific home appliance.

14. The control method of the internet home appliance system according to claim 13, wherein the wireless communication tag comprises an NFC tag, and
the external terminal recognizes the first information from the NFC tag and implements a specific home appliance application for the product processing.

15. The control method of the internet home appliance system according to claim 1, wherein the external terminal recognizes the first information and implements the application.

16. The control method of the internet home appliance system according to claim 1, wherein the external terminal implements the application and recognizes the first information.

17. The control method of the internet home appliance system according to claim 1, wherein an image for installing the application is displayed on the external terminal, unless the application is installed in the external terminal having recognized the first information.

18. The control method of the internet home appliance system according to claim 1, wherein an image for registering the home appliance in the server is displayed on the external terminal, unless a home appliance for the product processing is registered in the server in the external terminal having recognized the first information.

19. The control method of the internet home appliance system according to claim 1, wherein an image for allowing the user to select specific product processing information based on the first information is displayed on the application implemented in the external terminal.

20. The control method of the internet home appliance system according to claim 1, wherein the home appliance comprises,
an input unit configured to receive the user's input for setting the product processing information manually;
a display unit configured to display the set product processing information; and
a user interface unit configured to receive the user's input for starting the product processing based on the set product processing information.

21. The control method of the internet home appliance system according to claim 1, wherein the processing object product comprises clothing, and the home appliance comprises a washing machine, a dryer and a clothes management apparatus.

22. A control method of an internet home appliance system comprising:
a step of controlling a user to apply power through a power input unit manually selected by the user;
a step of registering a home appliance in a server and connecting the home appliance with the server by communication;
a step of receiving third information for product processing from the server and setting the product processing information;
a step of receiving an input for starting the product processing through a start input unit selected by the user manually; and
a step of processing the product based on the set product processing information,
wherein the product processing information is set based on first information that is recognized from the product through an external terminal by the user, second information that is transmitted to the server from the external terminal, and third information that is transmitted to the home appliance from the server.

23. An internet home appliance system comprising a server, a home appliance connected with the server by communication and registered in the server, and an external terminal connected with the server by communication,
wherein the home appliance comprises,
a user interface unit configured to set product processing information and a communication module configured to connect the home appliance with the server by communication, and
the external terminal comprises a NFC module configured to recognize first information from a processing object product and a communication module mounted to transmit second information to the server, and an application implemented in connection with a home appliance communicable with the server is installed in the external terminal, and
the server comprises a communication module configured to transmit third information to the home appliance to automatically set the product processing information in the home appliance.

24. A control method of an internet home appliance system configured to support a home appliance to automatically set product processing information in the home appliance, the control method comprising:
a step of recognizing first information from an information tag provided in a processing object product through the external terminal;
a step of recognizing the first information through the external terminal and implementing an application that is connectable with the home appliance registered in a server based on user information and appliance information by communication; and
a step of implementing the application through the external terminal and transmitting second information to the server to automatically set the product processing information in the home appliance after the server transmits third information to the home appliance.

25. The control method of the internet home appliance according to claim 24, further comprising:
a step of displaying an image for installing the application, unless the connectable application is installed in the external terminal having recognized the first information.

26. The control method of the internet home appliance according to claim 24, further comprising:
a step of displaying an image for registering the home appliance in the server, unless the home appliance for the product processing is registered in the server after the external terminal recognizes the first information.

27. The control method of the internet home appliance according to claim 24, further comprising:
a step of displaying an image for selecting specific product processing information based on the first information on the external terminal, while the application is implemented.
